(19) United States
(12) Patent Application Publication
(10) Pub. No.: US 2017/0346437 A1
(43) Pub. Date: Nov. 30, 2017

(54) BRACKET FOR CLAMPING A PHOTOVOLTAIC MODULE TO A TORQUE TUBE

(71) Applicant: OMCO Solar, LLC, Phoenix, AZ (US)

(72) Inventor: Todd Owen, Litchfield Park, AZ (US)

(73) Assignee: OMCO Solar, LLC, Phoenix, AZ (US)

(21) Appl. No.: 15/166,208

(22) Filed: May 26, 2016

(51) Int. Cl. H02S 20/32; F16B 35/00; F16B 4/00

(52) U.S. Cl. CPC H02S 20/32; F16B 4/004; F16B 35/00

(57) ABSTRACT

A bracket for clamping a photovoltaic module to a torque tube includes a planar base having a pair of aligned holes, a pair of bolts each extending through one of the pair of holes, and a plurality of securing tabs. Each of the securing tabs can be formed by bending a corner portion of the planar base downwardly to a desired angle. The pair of bolts extend to a sufficient length so as to permit a threaded portion of each bolt to be threaded into a complementary threaded hole of the photovoltaic module assembly (e.g., a rail supporting the photovoltaic module). The supporting tabs are structured and arranged to grip lateral sides of the torque tube. Advantageously, the dimensions allow the clamp to stay on the torque tube through a friction fit for ease of installation prior to threading the hardware into the photovoltaic module assembly.

### BACKGROUND OF THE INVENTION

### 1. Field of the Invention

The present invention relates to large area photovoltaic mounting structures, and more particularly, to a bracket useful for clamping a photovoltaic module to a torque tube.

### 2. Description of the Related Art

Photovoltaic modules can be electrically connected and arranged on various mounting structures to form a photovoltaic array. For large-area electricity generation, photovoltaic modules are often arranged on long frames elevated from a ground surface. To increase the amount of energy produced from the sun, solar trackers are often used to orient the panels toward direct sunlight that carries the most solar energy.

A solar tracker typically includes a frame with a torque tube that runs the length of the frame along a central axis. A standard torque tube has a 100 mm×100 mm (about 4 inches×4 inches) square cross section. The photovoltaic modules typically are attached to rails that rest perpendicularly to the torque tube. As the torque tube rotates along the axis, the photovoltaic array also rotates. The photovoltaic arrays are typically laid row upon row, and may take up many acres of outdoor space.

### SUMMARY OF THE INVENTION

A bracket for clamping a photovoltaic module to a torque tube includes a planar base having a pair of aligned holes, a pair of bolts each extending through one of the pair of holes, and a plurality of securing tabs. Each of the securing tabs can be formed by bending a corner portion of the planar base downwardly to a desired angle. The pair of bolts extend to a sufficient length so as to permit a threaded portion of each bolt to be threaded into a complementary threaded hole of the photovoltaic module assembly (e.g., a rail supporting the photovoltaic module). The supporting tabs are structured and arranged to grip lateral sides of the torque tube. Advantageously, the dimensions allow the clamp to stay on the torque tube through a friction fit for ease of installation prior to threading the hardware into the photovoltaic module assembly.

### BRIEF DESCRIPTION OF THE DRAWINGS

FIG. 1 illustrates a perspective view of an exemplary bracket for clamping a photovoltaic module to a torque tube.

FIG. 2 illustrates a bottom view of the bracket.

FIG. 3 illustrates a side view of the bracket.

FIG. 4 illustrates a side view of the bracket clamping a photovoltaic module to a torque tube.

FIG. 5 illustrates a perspective view of the bracket in use.

### DETAILED DESCRIPTION OF THE INVENTION

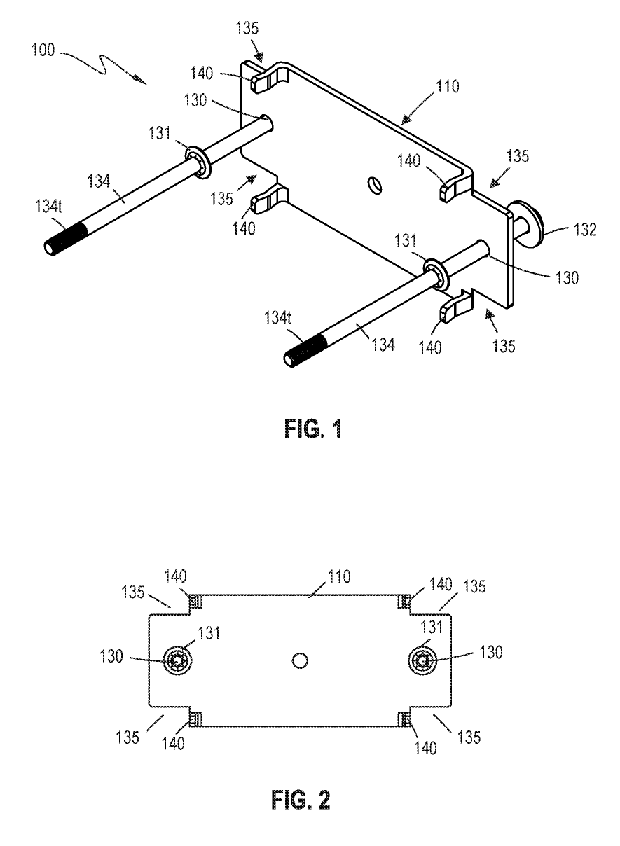

Referring to FIG. 1, a perspective view of an exemplary bracket 100 for clamping a photovoltaic module to a torque tube, according to an embodiment of the invention, is illustrated. As shown, the bracket 100 includes a planar base 110 having a pair of aligned holes 130, a pair of bolts 134 each extending through one of the pair of holes 130, and a plurality of securing tabs 140. Each of the securing tabs 140 can be formed by bending a corner portion of the planar base 110 downwardly to a desired angle, for example. As will be described in greater detail, the pair of bolts 130 extend to a sufficient length so as to permit a threaded portion 134t of each bolt 134 to be threaded into a complementary threaded hole of the photovoltaic module assembly, such as a rail supporting the photovoltaic module. The supporting tabs 140 are structured and arranged to grip lateral sides of the torque tube, and have a predetermined bending distance.

FIG. 2 illustrates a bottom view of the bracket 100 showing the lower surface of the planar base 110. As shown, the planar base 110 is a generally rectangular planar base, and includes inset corners 135.

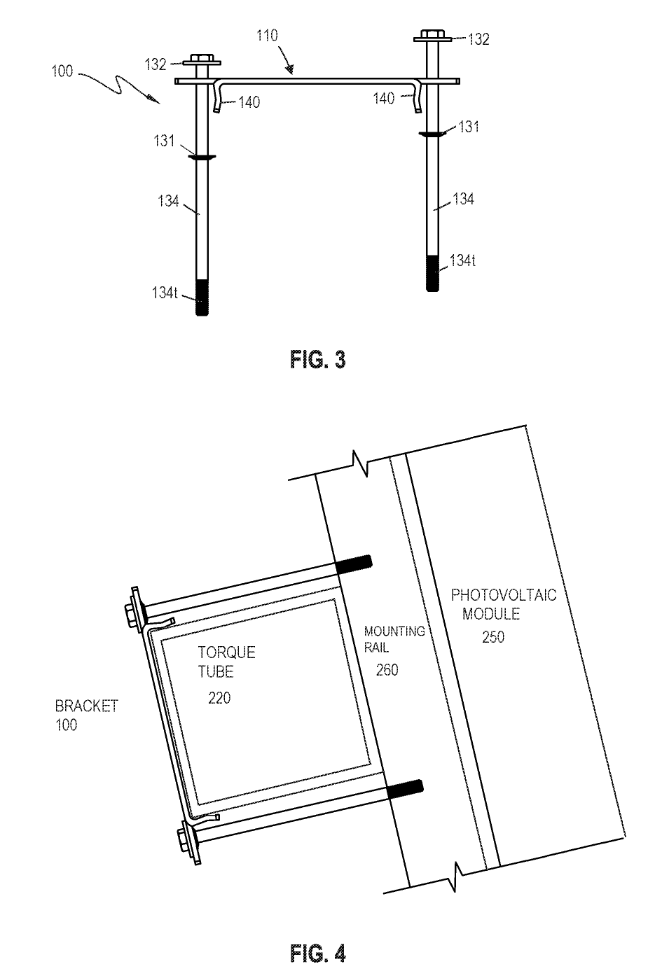

FIG. 3 illustrates a side view of the bracket. As shown, the pair of bolts 134 each includes a flat washer 132 and a retaining washer 134. Each flat washer 132 is positioned on the bolt 134 between the head of the bolt 134 and an upper surface of the planar base 110, and each retaining washer 131 is positioned on the bolt 134 adjacent the lower surface. It is to be understood that different types of washers from those shown may suffice. For instance, instead of the flat washer 132, a split lock or tooth lock washer, or perhaps no washer, could be used. Furthermore, instead of the retaining washer 131, a different type of retaining device could be used, such as a push nut. Preferably, each bracket 100 will be pre-assembled (as shown in FIG. 3) so as to include the planar base 110, the bolts 134 extending through the holes 130, and the washers 131, 134. Advantageously, the retaining washers 131 hold the bolts onto the bracket 100, and the bracket 100 can be easily installed in the field with all the necessary hardware already available in one place. During installation, the bracket 100 frictionally fits onto the torque bar and stays in place while the bolts are tightened.

Referring to FIG. 4, a side view of the bracket 100 attaching an example photovoltaic module 250 to a torque tube 200, according to an embodiment, is illustrated. As shown, the photovoltaic module 250 includes a mounting rail 260 attached thereto (e.g., using an adhesive). In operation, the mounting rail 260 is arranged perpendicularly to the torque tube 220, and there can be more than one such mounting rail 260 for each photovoltaic module 250, depending on the size and weight of the photovoltaic module 250, and other factors. In an embodiment, the mounting rail 260 has a “top hat” structure and includes threaded holes in the top surface to accommodate the threaded portions 134t of the bolts 134. In this embodiment, the photovoltaic module is a Series 5™ thin film solar module from First Solar of Tempe, Az. In this embodiment, the torque tube 220 has about a 100 mm×100 mm square cross section.

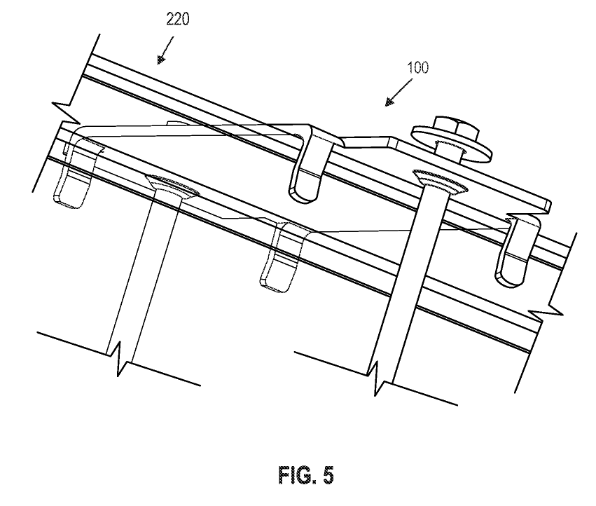

FIG. 5 illustrates a perspective view of the bracket 100 attaching a photovoltaic module 250 to the torque tube 220.

In operation, once the mounting frame is constructed, photovoltaic modules, such as the photovoltaic module 250, are each clamped to the torque tube 220 by frictionally fitting the bracket 100 against a side of the torque tube 220, and then screwing each of the bolts 134 into a corresponding threaded hole in the mounting rail 260. In many cases, there would be multiple rails for each photovoltaic module requiring usage of a multiple brackets 100 for each photovoltaic module.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A bracket, comprising:
a planar base;
a pair of holes disposed in the planar base; and
a pair of bolts, each extending through a respective hole in the planar base.

2. The bracket of claim 1, further comprising a plurality of securing tabs.

3. The bracket of claim 2, wherein the securing tabs are bendable.

4. The bracket of claim 2, wherein the securing tabs are disposed downwardly from the base.

5. The bracket of claim 1, wherein the bolts are sufficient in length to accommodate clamping a photovoltaic module to a torque tube.

6. The bracket of claim 5, wherein the torque tube has about a 100 mm×100 mm square cross section.

7. A method for securing a photovoltaic module to a torque tube, comprising:
providing the bracket of claim 1;
frictionally fitting a lower surface of the bracket against a side of the torque tube;
placing bolts of the bracket into corresponding threaded holes of a rail, the rail attached to the photovoltaic module; and
tightening each of the bolts.

8. The method of claim 7, wherein securing tabs of the bracket are disposed against lateral sides of the torque tube.
